(19) United States
(12) Patent Application Publication
(10) Pub. No.: US 2014/0250840 A1
(43) Pub. Date: Sep. 11, 2014

(54) Spiral Nail Polish Opener

(71) Applicant: Mathew Bradford, St. Louis, MO (US)

(72) Inventor: Mathew Bradford, St. Louis, MO (US)

(21) Appl. No.: 13/792,122

(22) Filed: Mar. 10, 2013

(51) Int. Cl. B67B 7/14; A45D 29/12

(52) U.S. Cl. CPC B67B 7/14; A45D 29/12
USPC 53/492; 81/3.4; 401/129

(57) ABSTRACT

A helical, easy-to-utilize reusable grip for a nail polish bottle that wraps around said elongated handle of a nail polish bottle in a winding fashion.

### BACKGROUND

1. Field of the Invention

This disclosure is related to the field of devices, systems and methods to assist in the opening of finger nail polish bottles.

2. Description of Related Art

The ubiquitous container (100) utilized by the beauty products industry for the storing and application of nail polish generally consists of a body member (101) and a polish applicator handle (102), as demonstrated in FIG. 1. The body member (101) is generally comprised of a chamber for holding polish (103) and a threaded neck (104). The polish applicator handle (102) is generally comprised of an internally threaded elongated handle (105) which corresponds to the neck (104) and an applicator (106) which extends from the elongated handle (105). The polish applicator (106) is utilized to apply nail polish to the fingernails of a customer in a known manner. Generally, the polish applicator (106) is affixed to and extends away from the center of the internally threaded elongated handle (105) so that when it is threaded onto a threaded neck (104) of the body member (101), the nail polish applicator (106) will extend into the nail polish housed in the chamber (103). Although the shapes and sizes of the nail polish bottle (100) used in the beauty industry can vary amongst brands and manufacturers (e.g., different shaped body member (101) and elongated handle (105)) the majority of nail polish bottles (100) utilized in the industry all have the elements described above of a body member (101) holding the polish and an elongated handle (105) which holds the polish applicator, with the elongated handle (105) threading onto the neck (104) of the body member (101).

One of the biggest problems and sources of frustration for manicurists and others who utilize nail polish is detaching the internally threaded elongated handle (105) from the body member (101). Finger nail polishes generally have a lacquer base to enable them to be applied easily to the nail and provide a quick drying and strongly adhesive coating for the nail. However, it is commonplace in the industry for a manicurist or other user to wipe excess nail polish off the nail polish applicator (106) with the neck (104) of the body member (101). This activity or even simple use of the nail polish bottle (100) without wiping often results in nail polish finding its way between the screw thread neck (104) of the body member (101) in which it is stored and the elongated handle (105). The build-up and drying of this nail polish on the threads of the neck (104) and the mating threads of the elongated handle (105) causes the elongated handle (105) to become stuck, adhered or frozen to the body member (101), causing much frustration for a user and, in certain instances, resulting in a user having to throw out the bottle (100) before the nail polish in it is completely used because the bottle (100) can't be opened. In addition, if a user applies too much force to the nail polish bottle (100) to release the elongated handle (105), the user is at risk of breaking the neck (104) of the body member (101) or the elongated handle (105).

Due to this widely experienced frustration and difficulty in opening nail polish bottles (100), many opening tips and devices have emerged in the art. One method is placing the elongated handle (105) in a bath of warm to hot water to liquefy the polish so the elongated handle (105) can easily be unscrewed. Not only is this process cumbersome and unduly time intensive, the heat of the water can ruin the nail polish formula and the label. Another process often utilized by manicurists and other users is applying nail polish remover with a Q-Tip® in the space between the neck (104) and the elongated handle (105), loosening up the hardened nail polish. This process is problematic because of the additional secondary materials and the excess time it requires. In addition, this process is often ineffective because it doesn't affect dried nail polish located on the threads of the elongated neck (104) inside the elongated handle (105).

In addition to the aforementioned opening techniques, there are also tools on the market to assist manicurists and users in opening stubborn nail polish bottles (100). These tools include wrench like objects that are used alone, or with specially manufactured bottles (100). The problem with these tools are their high cost, cumbersome nature and their inability to effectively work across a wide range of nail polish bottles (100) and shapes. Further, wrench-like objects can often crush the relatively thin plastic from which the elongated handle (105) is constructed, thereby destroying the bottle (100). Other devices include rubber sleeves that are placed over the elongated handle (105) that generally cover the entirety of the elongated handle (105). These devices can be problematic because, often, they do not fit the wide variety of nail polish bottles (100) and different shaped elongated handle (105) styles available in the art. Accordingly, there is a need in the art for an inexpensive and easily molded and assembled device with a minimum number of parts for assisting in the opening of nail polish bottles (100).

### SUMMARY

Because of these and other problems in the art, described herein, among other things, is a nail polish opener for a nail polish bottle comprising: a main body formed into a helix and including an interior surface and an exterior surface, wherein the helix has an interior diameter sized and shaped to contact an elongated handle of a nail polish bottle.

In an embodiment of the nail polish opener, the interior surface is generally flat.

In an embodiment of the nail polish opener, the interior surface is textured.

In an embodiment of the nail polish opener, the exterior surface is adorned with a design.

In an embodiment of the nail polish opener, the exterior surface functions as an advertisement.

In an embodiment of the nail polish opener, the nail polish opener is comprised of a material chosen from the group consisting of: rubber, silicone and plastic.

In an embodiment of the nail polish opener, the interior diameter is less than an exterior diameter of the elongated handle.

In an embodiment of the nail polish opener, the helix has a counter-clockwise upward rotation.

In an embodiment of the nail polish opener, the helix has a clockwise upward rotation

There is also described herein, a bottle of nail polish and a nail polish opener in combination, the combination comprising: a bottle of nail polish including a body member and an elongated handle having an exterior surface screwably connected to the body member. A nail polish opener including: a main body formed into a helix and including an interior surface and an exterior surface, wherein the interior surface of the nail polish opener is in contact with the exterior surface of the elongated handle.

In an embodiment of the combination, the helix has a counter-clockwise upward rotation.

In an embodiment of the combination, the helix has a clockwise upward rotation.

In an embodiment of the combination, the interior surface of the nail polish opener is generally flat.

In an embodiment of the combination, the interior surface of the nail polish opener is textured.

In an embodiment of the combination, the exterior surface of the nail polish opener is adorned with a design.

In an embodiment of the combination, the nail polish opener is comprised of a material chosen from the group consisting of: rubber, silicone and plastic.

There is also described herein a method of opening a bottle of nail polish. The method comprising: providing a bottle of nail polish including a body member and an elongated handle having an exterior surface screwably connected to the body member; providing a nail polish opener including: a main body formed into a helix having an internal diameter and including an interior surface and an exterior surface, twisting the main body so as to increase the internal diameter and placing the main body around the elongated handle and releasing the main body allowing the main body to contact the elongated handle and grasping the main body and the elongated handle and twisting the main body.

### BRIEF DESCRIPTION OF THE DRAWINGS

FIG. 1 depicts a nail polish bottle of the prior art.

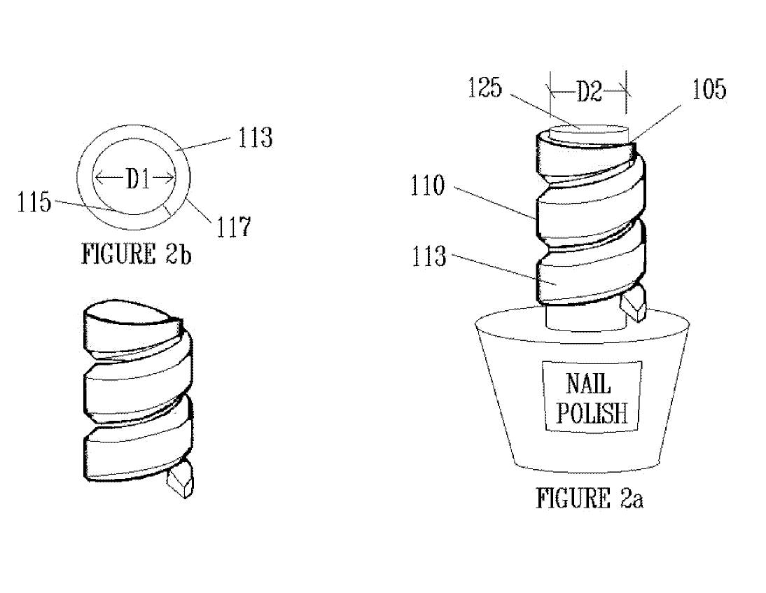

FIGS. 2A, 2B, and 2C depict various views of the disclosed nail polish bottle opener. FIG. 2A depicts a side view of the nail polish bottle opener with a counter-clockwise upward spiral on the elongated handle of a nail polish bottle. FIG. 2B depicts a top view of the nail polish bottle opener of FIG. 2C. FIG. 2C depicts a side view of the nail polish bottle opener with a clockwise upward spiral on the elongated handle of a nail polish bottle

FIGS. 3A, 3B, 3C, 3D, 3E, 3F, 3G and 3H depict various embodiments of different ornamental designs on the exterior of the nail polish bottle opener.

### DESCRIPTION OF THE PREFERRED EMBODIMENTS

This disclosure is intended to teach by way of example and not by way of limitation.

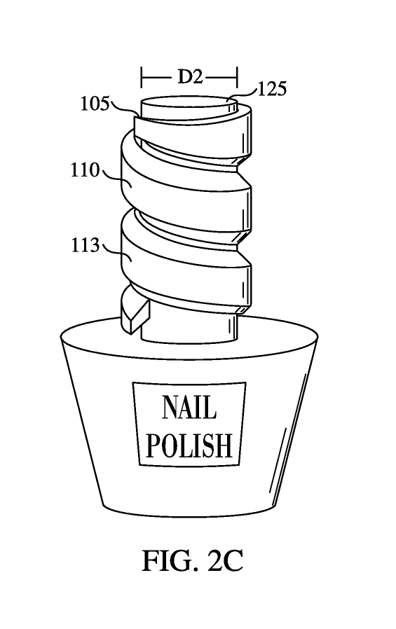

As demonstrated in the embodiment depicted in FIGS. 2A-2C, the nail polish bottle opener (110) described herein has a main body (113) with a helical design. Stated differently, the nail polish bottle opener (110) is a three-dimensional curve that turns around an axis at a constant or continuously varying distance while moving parallel to an axis. The nail polish opener (110) is applied vertically to the elongated handle (105) over the top (125), as demonstrated in FIGS. 2A and 2C, allowing the main body (113) of the nail polish opener (110) to wrap around the length of the elongated handle (105) in a winding fashion. Alternatively, the opener (110) may be provided with the main body (113) in a linear arrangement which is biased toward a helical arrangement which can be rolled around the elongated handle (105) in the indicated helical fashion.

The orientation of the main body (113) of the nail polish opener (110) relative to the elongated handle (105) allows the nail polish opener (110) to grip the elongated handle (105) and provide superior grip to the elongated handle (105). The helical orientation of the nail polish opener (110) is utilized because it offers greater grip strength and, because of the threaded neck (104) and elongated handle (105), a superior tangential application of energy for opening the elongated handle (105).

In certain embodiments, it is contemplated that the internal diameter (D1) of the helix of the nail polish bottle opener (110) will be generally smaller than the outer diameter (D2) of the elongated handle (105), although this arrangement is not required. In such an embodiment, the nail polish bottle opener (110) is generally twisted (i.e., partially uncoiled in hand to increase the internal diameter (D1)) and then placed on the elongated handle (105). The twisting is then released so that the internal diameter (D1) attempts to restore itself. The smaller internal diameter (D1) is generally not completely restored and this allows the nail polish bottle opener (110) to better grab the elongated handle (105) as the nail polish bottle opener (110) and elongated handle (105) combination is twisted and manipulated by a user as the opener (110) will be pushing against the elongated handle's outer surface based on its restoration force.

In an embodiment of the helical nail polish bottle opener, the helix will be oriented in a counter-clockwise upwards rotation as demonstrated in FIG. 2A. Alternatively, the helix will be oriented in a clockwise upwards rotation as demonstrated in FIG. 2C. The latter is generally preferred as this means that rotating the elongated handle (105) in the opening direction (counter clockwise) will generally cause the helix to attempt to reduce the inner diameter (Dl). Thus, as the user twists the helix and elongated handle (105) combination, the helix will tend to tighten (decreasing the diameter (D1)) on the elongated handle (105) increasing the friction and the turning power. When turning the opener (110) and elongated handle (105) combination in the other direction, the helix will tend to loosen (increasing the diameter (D1)). Thus, the user turning the opener with identical force in both directions will generally have a stronger grip (more applied force) to the elongated handle (105) to open it that to close it.

In the embodiment of FIG. 2A, the turning of the helix is reversed, as unscrewing the elongated handle (105) in the counter-clockwise direction will generally cause the helix to open. Both embodiments are contemplated to deal with caps that may have different handedness of the threads. Also, the effect of the opening and closing of the helix will generally only be significant for extremely tight connections (where a user is providing a great deal of force to the elongated handle (105) and opener (110)) and therefore one design or the other may be chosen for aesthetics as well.

To utilize the nail polish opener (110), a user slides the nail polish opener (110) over the elongated handle (105) of the nail polish bottle (100) so as to place it in the position of FIG. 2A or 2C. Then the user applies pressure to and grips the nail polish opener (110) which engages the elongated handle (105) outer surface with a strong frictional connection. The user then rotates the nail polish opener (110) and elongated handle (105) combination in the correct direction to release the elongated handle (105) from the body member (101). In most embodiments, this will be in a counterclockwise direction. It is also an option for a user to grip on the nail polish opener (110) and elongated handle (105) combination and twist the body member (101) and/or the nail polish opener (110) and elongated handle (105) combination to open the nail polish bottle. When the nail polish bottle (100) is opened, the user can then remove the nail polish opener (110) and use it on another nail polish bottle (100) when required or leave it in place.

Generally, as demonstrated in FIGS. 2B, the interior surface of the nail polish opener (110) is generally flat. This orientation creates a broad surface area between the elongated handle and the nail polish opener (110), thus maximizing the friction between the nail polish opener and the elongated handle (105). In an alternative embodiment, the interior surface (115) may be textured to provide for different coefficients of friction, possibly depending on the direction of rotation. In this way, the friction can be increased as the elongated handle is opened and decreased as it is closed. Thus, the user has greater force on the elongated handle (105) when opening than closing, which can help to reduce them closing the bottle (100) too tightly.

The exterior surface of the nail polish opener (110), as demonstrated in FIG. 2B, is generally raised off the elongated handle (105). Notably, the width from the interior surface (115) to the exterior surface (117) of the nail polish opener (110) is not determinative but can be any thickness. Any thickness that allows for a user to adequately grip the nail polish opener (110) and elongated handle (105) combination without it being cumbersome is contemplated in this application.

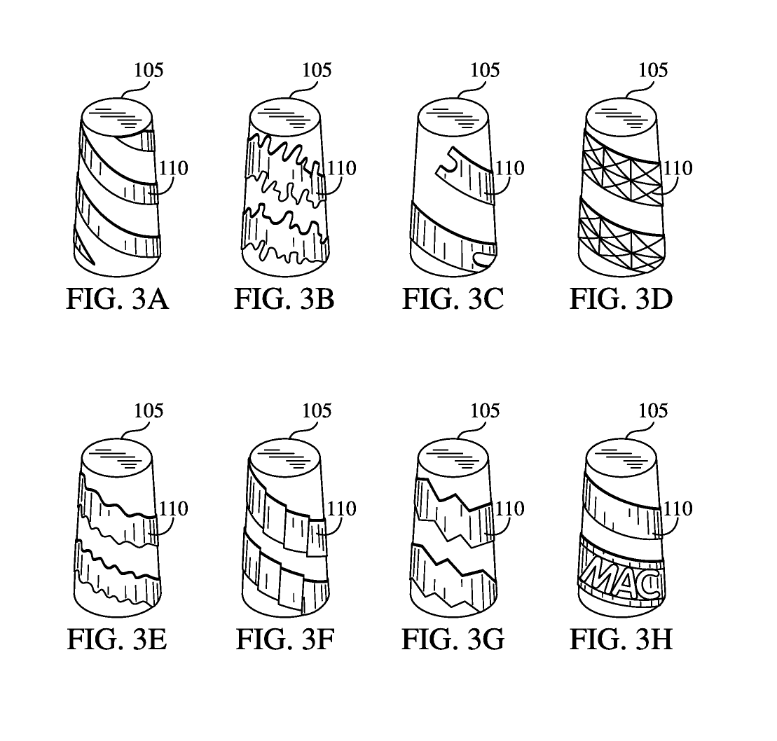

In various alternative embodiments, as depicted in FIG. 3, it is contemplated that the exterior of the nail polish opener (110) may be adorned with or take a plurality of different designs. For example, in one embodiment it is contemplated that the nail polish opener (110) can also function as a form of advertisement. In these embodiments, the name of the nail polish brand, manufacturer and/or nail salon is emblazoned on the exterior of the nail polish opener (110). Similarly, in other embodiments it is contemplated that a popular word or saying like “Styl'n” may be utilized on the exterior of the nail polish opener (110).

Irrespective of the exterior design, it is contemplated that the nail polish opener (110) will be comprised of a variety of materials including, but not limited to, plastics, rubber, silicone or other resilient, flexible, pliable material known to those of ordinary skill in the art. This pliable material, along with the nail polish opener's (110) helical shape, allows the nail polish opener (110) to expand and fit multiple size nail polish handles. Further, the helical shape and the high friction pliable material that comprises the nail polish opener (110) provides additional grip for opening and holding the elongated handle (105). In addition, in alternative embodiments it is contemplated that the exterior surface of the nail polish opener will further comprise raised bumps, ridges, or other known design which makes the exterior surface (117) easier or more comfortable to grip for a user.

In an embodiment, the interior surface (115) may include an adhesive. In an embodiment, this can provide an essentially permanent connection to the elongated handle (105) but dramatically increasing the friction between the opener (110) and the elongated handle (105). Alternatively, this may be a lower strength adhesive and provide for a temporary connection, but increase the coefficient of friction. Further, while this application generally contemplates that the opener (110) be reusable between a number of different bottles (100), in an alternative embodiment, the opener (110) may be disposable and generally be thrown away with the bottle (100) once the nail polish therein has been used up.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A nail polish opener for a nail polish bottle comprising:
a main body formed into a helix and including:
an interior surface; and
an exterior surface;
wherein said helix has an interior diameter sized and shaped to contact an elongated handle of a nail polish bottle.

2. The nail polish opener of claim 1, wherein said interior surface is generally flat.

3. The nail polish opener of claim 1, wherein said interior surface is textured.

4. The nail polish opener of claim 1, wherein said exterior surface is adorned with a design.

5. The nail polish opener of claim 3, wherein said exterior surface functions as an advertisement.

6. The nail polish opener of claim 1, wherein said nail polish opener is comprised of a material chosen from the group consisting of: rubber, silicone and plastic.

7. The nail polish opener of claim 1 wherein said interior diameter is less than an exterior diameter of said elongated handle.

8. The nail polish opener of claim 1 wherein said helix has a counter-clockwise upward rotation.

9. The nail polish opener of claim 1 wherein said helix has a clockwise upward rotation.

10. A bottle of nail polish and a nail polish opener in combination, said combination comprising:
a bottle of nail polish including:
a body member; and
an elongated handle having an exterior surface screwably connected to said body member; and
a nail polish opener including:
a main body formed into a helix and including:
an interior surface; and
an exterior surface;
wherein said interior surface of said nail polish opener is in contact with said exterior surface of said elongated handle.

11. The combination of claim 10, wherein said helix has a counter-clockwise upward rotation.

12. The combination of claim 10, wherein said helix has a clockwise upward rotation.

13. The combination of claim 10, wherein said interior surface of said nail polish opener is generally flat.

14. The combination of claim 10, wherein said interior surface of said nail polish opener is textured.

15. The combination of claim 1, wherein said exterior surface of said nail polish opener is adorned with a design.

16. The combination of claim 1, wherein said nail polish opener is comprised of a material chosen from the group consisting of: rubber, silicone and plastic.

17. A method of opening a bottle of nail polish, said method comprising:
providing a bottle of nail polish including:
a body member; and
an elongated handle having an exterior surface screwably connected to said body member;
providing a nail polish opener including:
a main body formed into a helix having an internal diameter and including:
an interior surface; and
an exterior surface;
twisting said main body so as to increase said internal diameter;
placing said main body around said elongated handle;
releasing said main body allowing said main body to contact said elongated handle;
grasping said main body and said elongated handle; and
twisting said main body.
